(19) United States
(12) Patent Application Publication
(10) Pub. No.: US 2009/0245131 A1
(43) Pub. Date: Oct. 1, 2009

(54) Remotely controlled gateway management with security

(76) Inventors: Lukasz Marek Szostek, Eindhoven (NL); Leendert Teunis Rozendaal, Valkenswaard (NL)

Correspondence Address: PHILIPS INTELLECTUAL PROPERTY & STANDARDS, P.O. BOX 3001, BRIARCLIFF MANOR, NY, 10510, US

(21) Appl. No.: 10/586,702

(22) PCT Filed: Jan. 17, 2005
(86) PCT No.: PCT/IB05/50190

§ 371 Date: Jul. 20, 2006

Related U.S. Application Data
(60) Provisional application No. 60/537,809, filed on Jan. 20, 2004.

(51) Int. Cl. H04L 12/28; H04L 12/56

(52) U.S. Cl. 370/254; 370/401

(57) ABSTRACT

A system and method are disclosed for remotely controlled gateway (135) management. The method and apparatus receive a request (120-1, 120-2) for content (164), the request (120-1, 120-2) comprising global addressing information (125-2, 126-2) of a gateway (135) and corresponding to a network appliance 105 on a local network (165) accessible by the gateway (135). The method and apparatus determine gateway configuration information (139, 145, 134) suitable for configuring the gateway (135) to pass one or more content streams 190 comprising portions of the content (164) to the network appliance 105. The method and apparatus communicate the gateway configuration information (139, 145, 134) to the gateway (135).

The present invention relates to communication over networks, and more particularly, to communication between two networks using gateways.

A gateway for a small network typically includes a firewall and a router. The firewall prevents unauthorized access to the small network (called a “local network” herein), thereby protecting the local network from outside intruders. The router translates incoming and outgoing traffic. For example, a network appliance in the local network will generally create outgoing packets that use a local address and local port for the network appliance. The local address and local port are not valid outside the local network, so the router will translate these to a global address and global port, which are valid in the external network. The gateway generally replaces the local address with its own global address and the local port with one of its own ports. The revised packet is then sent to its destination on the external network. Packets received by the router from the destination will have the global address and a global port of the router in the received packets. The router then replaces the global address and global port of the router with the local address and local port of the network appliance and forwards the packets to the local network.

Currently, the configuration of a gateway installed between local networks, such as home networks, and an external network, such as the Internet, is performed by the user. A problem with this is that the configuration of a gateway can at times be complex and cumbersome. For example, there are applications, especially applications handling multimedia, that use a number of real-time content streams. A typical multimedia application generally starts with a single, non-streaming connection for accessing a remote server on the external network. However, the multimedia application generally creates a number of connections with streams of multimedia data coming into the local network and/or a number of connections with streams of control information or multimedia data going out of the local network. The number of incoming connections (with associated local addresses and local ports) being used can create problems for a gateway, as both the firewall and the router have to handle all of these multimedia content streams while still blocking unwanted access to the local network and correctly routing the multimedia content streams to the proper network appliance(s) on the local network.

A need therefore exists for improved methods and apparatus for gateway management.

Generally, a system and method are disclosed that provide remotely located gateway management with security, which provides, for example, automatic configuration of gateways.

In an exemplary aspect of the invention, a system and method are disclosed for remotely controlled gateway management. The method and apparatus receive a request for content, the request comprising global addressing information of a gateway and corresponding to a network appliance on a local network accessible via the gateway. The method and apparatus determine gateway configuration information suitable for configuring the gateway to pass one or more content streams, each comprising portions of the content, to the network appliance. The method and apparatus communicate the gateway configuration information to the gateway.

In another exemplary aspect of the invention, a second method and apparatus are disclosed. The second method and apparatus send a request for content, where the request comprises global addressing information of a gateway and corresponds to a network appliance on a local network accessible via the gateway. The second method and apparatus receive gateway configuration information suitable for configuring the gateway to pass one or more content streams, each comprising portions of the content, to the network appliance. The second method and apparatus configure the gateway in accordance with the gateway configuration information.

A more complete understanding of the present invention, as well as further features and advantages of the present invention, will be obtained by reference to the following detailed description and drawings.

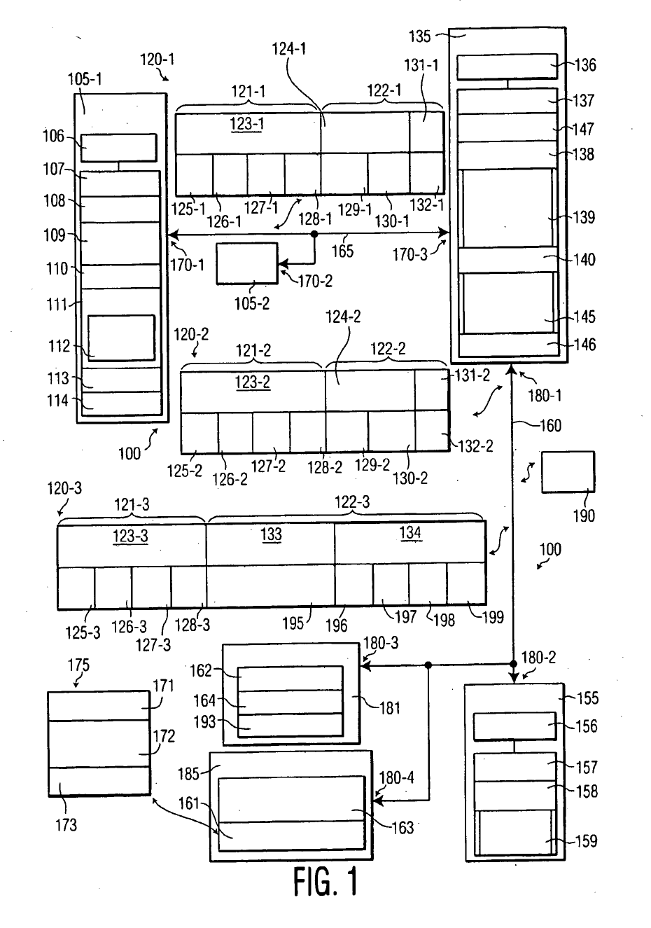

FIG. 1 is a block diagram of a system operating in accordance with an exemplary embodiment of the present invention;

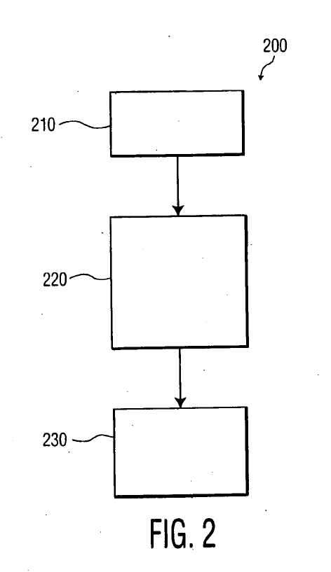

FIG. 2 is a flowchart of an exemplary method performed by a network appliance in order to provide remotely controlled gateway management;

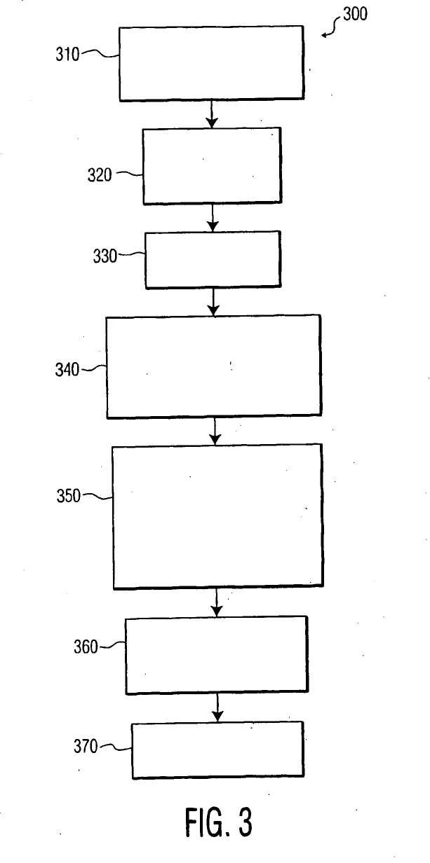

FIG. 3 is a flowchart of an exemplary method performed by a gateway in order to provide remotely controlled gateway management; and

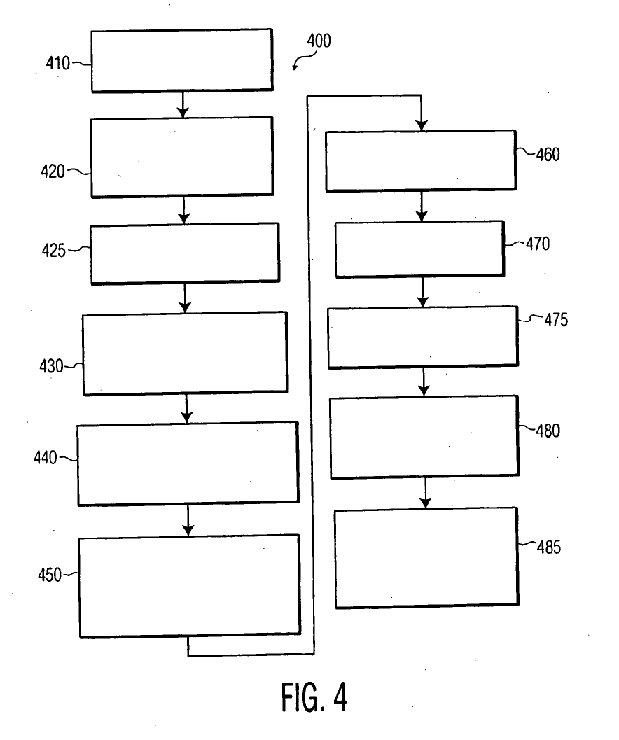

FIG. 4 is a flowchart of an exemplary method performed by one or more servers in order to provide remotely controlled gateway management.

As described above, there are problems with certain applications, particularly multimedia applications, which use a number of incoming and outgoing content streams. These content streams in a local network typically pass through a gateway. A gateway is a device separating two or more networks. As previously described, a gateway generally provides address and port translation, and typically protects resources of the local network from users of an external network. The gateway has to route all of the incoming and outgoing content streams. Outgoing content streams typically are not problematic, as the application creating the outgoing content streams already includes external destination addresses. Incoming content streams, however, can be problematic.

For certain incoming content streams, a user has to access the gateway and configure it to allow the incoming content streams and corresponding local address/port information. For instance, NetMeeting, a communication application from Microsoft, requires certain ports for Transmission Control Protocol (TCP) and Real-Time Transfer Protocol (RTP) over User Datagram Protocol (UDP) connections. The user has to configure the gateway to allow NetMeeting to work correctly. This is even more difficult since the port numbers used may vary between invocations of the application. Similarly, a network appliance, such as a Philips Internet radio, can request audio streams from a radio server. This radio server will then stream the audio to the gateway. Typically some type of user intervention is required in order to configure the gateway to accept the content stream and route it to the correct network appliance on the local network.

One possible solution for these problems is an Application Level Gateway (ALG). An ALG can be provided in a gateway to examine outgoing and incoming packets and to correct any addresses or ports in the packets, and to update the configuration of the router and/or firewall as needed. This way, incoming multimedia content streams meant for a particular application running on a network appliance in a local network would be correctly sent to the network appliance. However, each application then requires an ALG specific to this application to support its particular protocol. So, an application designer must create a specific ALG for each relevant application and install the ALG on the gateway.

The present invention fixes these problems by providing remotely controlled gateway management with security. In an exemplary embodiment, a network appliance connects to a server to retrieve content, which is typically multimedia content requiring perhaps several incoming multimedia content streams. The network appliance could include its local address and/or port number(s) in a request to the server for the multimedia content. The server determines how to configure a gateway corresponding to the network appliance so that the gateway will pass the incoming multimedia content streams and direct these incoming content streams to the correct network appliance on the local network. Thus, this exemplary embodiment allows automatic configuration of gateways, which lessens work to be done by the user and reduces the number of ALGs that have to be provided.

Turning now to FIG. 1, an exemplary system 100 is shown operating in accordance with the present invention. System 100 shows a local network 165 in communication with an external network 160 through a gateway 135. Local network 165 comprises network appliances 105-1 and 105-2, each of which has a local address 170-1, 170-2, respectively. Typically, these local addresses 170 are Internet Protocol (IP) addresses. The gateway 135 also has a local address 170-3, which is also typically an IP address, and has a global address 180-1. External network 160 comprises a remote server 155, a multimedia server 181, and a configuration server 185. Remote server 155 has a global address 180-2, multimedia server 181 has a global address 180-3 and configuration server 185 has a global address 180-4. Although only one local address 170 or global address 180 is shown for the devices in FIG. 1, it should be noted that these devices can have multiple local addresses 170, global addresses 180, or some combination thereof.

Network appliance 105-1 comprises a processor 106 coupled to a memory 107. Memory 107 comprises an application 108, an operating system 109, a communication stack 110, a temporary storage 111, and a port 113. The temporary storage 111 comprises a reference 112 to multimedia content 164. Network appliance 105-2 is expected to be similar to network appliance 105-1, but details of network appliance 105-2 are omitted for space reasons. Gateway 135 comprises a processor 136 coupled to a memory 137. Memory 137 comprises a router 138, a firewall 140, a number of global ports 146, and a remote programming interface 147. Router 138 comprises gateway configuration information 139, which in this example is one or more tuples (server address, server port, global port, server global address, local address, and local port). Note that some of the elements of the above tuple may be absent or not used. Firewall 140 also comprises gateway configuration information 145, which is this example is a server address, server port, gateway global address, and a global port. Although not shown in FIG. 1, the gateway 135 will typically also contain local ports.

Remote server 155 comprises a processor 156 coupled to a memory 157. Memory 157 comprises a web page 158. Web page 158 comprises a link 159 to the multimedia content 164. Multimedia server 181 comprises a content server 162, multimedia content 164, and a number of ports 193 (called “multimedia” ports 193 for ease of reference). Configuration server 185 comprises a gateway configuration module 163 and a network appliance registration database 161. FIG. 1 shows an exemplary entry 175 of network appliance registration database 161. Entry 175 comprises network appliance registration information of a gateway type 171, communication information 172, and one or more network appliance identifications (IDs) 173. Although not shown in FIG. 1, multimedia server 181 and configuration server 185 will each have a processor and a memory coupled to the processor.

Network appliances 105 are any electronic system suitable for connecting to a network. For example, network appliances 105 could be cellular phones, home computer systems, set-top boxes, or Personal Digital Assistants (PDAs).

As used herein, local addresses are addresses and local ports are ports valid in “local” network 165. Global addresses are addresses and global ports are ports valid in “external” network 160. It should be noted that the terms “local” and “external” are for expository purposes only. Generally, a local network 165 will be a home network or other small network, and external network 160 will be a large network such as the Internet. However, there is no requirement for this configuration and a network appliance 105 can connect to both small and large networks.

Typically, gateway 135 and remote server 155 will comprise operating systems (not shown). Remote server 155 will also generally comprise a communication stack (not shown). Gateway 135 might also comprise a communication stack (not shown).

A user generally interacts with remote server 155 and typically does not know of the existence of multimedia server 181 and configuration server 185. The user, using an application 108 such as a web browser, activates the reference 112 to multimedia content 164, where the reference 112 could be a hyperlink using HyperText Transfer Protocol (HTTP). The hyperlink is from web page 158 and is a version of link 159 to the multimedia content 164. Typically, there will be more than one reference 112 to more than one link 159 and, consequently, to more than one multimedia content 164. For simplicity, only one reference 112 and link 159 is shown. A user selects multimedia content 164 by activating the reference 112, such as “clicking” on a hyperlink. The initial request may also be, for example, a connection request performed by a communication application. The application 108 then creates information suitable for creating a payload 122-1 of packet 120-1.

Packet 120-1 comprises headers 121-1 and payload 122-1. The headers 121-1 comprise header address information 123-1, which comprises network appliance address 125-1, network appliance port 126-1, server address 127-1, and server port 128-1. The payload 122-1 comprises optional payload address information (e.g., comprising local address 129-1 and local port 130-1) and data 131-1 (e.g., comprising a unique network appliance identification). A packet 120-2 is shown after passing through gateway 135 for communication with remote server 155. A packet 120-3 is also shown that originates from configuration server 185 for communication with gateway 135.

The types of headers 121 used are determined by the protocols being used. For example, when using Transmission Control Protocol (TCP), a packet 120 will include, in headers 121, an IP header and a TCP header. As another example, when using the User Datagram Protocol (UDP), a packet 120 will include, in headers 121, an IP header and a UDP header. The IP header generally contains the source IP address and destination IP address. The TCP and UDP header contain the source port and destination port. As another example, in the case of IP security extensions (IPsec) encapsulating security protocol (ESP), the IP header is followed by an IPsec header. Thus, the exact configuration of the headers 121 can change depending on the protocol being used. For simplicity, it will be assumed herein that the header address information 123 is as shown in FIG. 1, although the techniques of the present invention are suitable for many different header types and corresponding protocols.

The communication stack 110, which is typically a TCP-Internet Protocol (TCP-IP) stack, creates packet 120-1 including information supplied by, in this example, application 108. In this example, the local address 129-1, the local port 130-1 (generally optional), and network appliance identification (ID), also optional, are supplied by the application 108. The communication stack 110 adds this information to the payload 122-1. The communication stack 110 also adds network appliance address 125-1 (e.g., as a source address), network appliance port 126-1 (e.g., as a source port), server address 127-1 (e.g., as a destination address), and server port 128-1 (e.g., as a destination port). The network appliance address 125-1 is typically the local address 170-1 and the network appliance port 126-1 is typically a port 113. In this example, packet 120-1 is a packet generated as a request to the remote server 155 for multimedia content 164, and the packet could be included as part of one or more packets sent to the remote server 155 to indicate, for example, a selection of a hyperlink corresponding to the multimedia content 164 or as a separate packet.

The request, in this example packet 120-1, can be generated by application 108, which could be, for instance, a plugin for a web browser, a web browser, a communication application, or a multimedia application. Alternatively, generation of the request could be performed by a component of the operating system 109, such as communication stack 110. It should be understood that the request, embodied in this example as packet 120-1, is only exemplary. The request need not contain all of the information shown. For example, the local address 129-1 may in some cases not be necessary. Similarly, the local port 130-1 and network appliance ID 132-1 might not be needed in certain applications. Additionally a request might be embodied in multiple packets 120. Furthermore, there could be multiple local addresses 129-1 and local ports 130-1 included in a request.

The local address 129-1 is typically the local address 170-1 of the network appliance 105-1. This information is useful so that the remote server 155, when supplying gateway configuration information suitable for configuring gateway 135 for use with a content stream 190 created from multimedia content 164, can inform the gateway 135 as to which network appliance 105 the content stream 190 is to be passed. The local port 130-1 is typically a port 113 on the network appliance 105-1. Although only one port 113 is shown, multiple ports 113 can exist and the local port 130-1 is then one selected port 113 from the network appliance 105-1. The local port 130-1 may be the same port 113 as network appliance port 126-1 or, more likely, a different port 113.

The server address 127-1 is generally the global address 180-2 of the remote server 155, while the server port 128-1 is a port (not shown) on the remote server 155. The global address 180-2 is typically an IP address.

Packet 120-1 passes through gateway 135, which separates local network 165 and external network 160. Router 138 replaces the network appliance address 125-1 with a gateway address 125-2 and replaces the network appliance port 126-1 with a gateway port 126-2. The gateway address 125-2 is typically the global address 180-1, which is generally an IP address. The gateway port 126-2 is one of the global ports 146. Generally, the router 138 leaves the other information in packet 120-1 the same when modifying the packet 120-1 to create packet 120-2: the server address 127-2 is the server address 127-1; the server port 128-2 is the server port 128-1; the local address 129-2 is the local address 129-1; the local port 130-2 is the local port 130-1; the network appliance ID 132-2 is the network appliance ID 132-1; and the rest of the headers 121-2 and payload 122-2 is the same as the rest of the headers 121-1 and payload 122-1, respectively.

Gateway 135 places packet 120-2 on external network 160. After routing through external network 160, the remote server 155 will receive the packet. The remote server 155 will then determine that the network appliance 105 needs the multimedia content 164 and will also forward packet 120-2, or some of the information in that packet, to the configuration server 185.

The gateway configuration module 163 of configuration server 185 will use the local address 129-2 and/or local port 130-2 and/or other relevant information, when creating a packet 120-3, which contains a configuration command 133 suitable for configuring the gateway 135 to pass the content stream 190 (e.g., to be created from multimedia content 164 by multimedia server 181) over a suitable global port 146, and possibly through a local port (not shown) for the gateway, and to the network appliance 105-1. It should also be noted that the packet 120-3 could be considered to be a command suitable for configuring the gateway 135 to pass the content stream 190 to the network appliance 105-1. The configuration commands 133 can include multiple port opening requests, port mapping requests, other gateway configuration requests, or some combination thereof, depending on the type of multimedia content 164. For instance, the gateway configuration module 163 for movies might request that several global ports 146 be open for audio, video, and other data.

Illustratively, there will a period of communication between the gateway 135 and the configuration server 185 where the configuration server 185 uses the remote programming interface 147 to determine, for example, what global ports 146 are available on the gateway 135. The configuration server 185 can then create gateway configuration information 134, which is used by the gateway 135 when configuring the gateway 135.

In the example of FIG. 1, the payload 122-3 comprises configuration commands 133, and optionally, other gateway configuration information 134. Configuration commands 133 illustratively comprise a configuration command 195, which instructs the gateway 135 to open a port and map content arriving on that port to a local port on a network appliance. The gateway configuration information 134 illustratively comprises a local address 196 (typically local address 129-2, which is usually local address 170-1), a local port 197 (typically local port 130-2, which is usually a port 113), an address of the server sending the content (“MSVR ADDR” 198, which is the global address 180-3 of the multimedia server 181) and a port of the server sending the content (“MSVR PORT” 199, which is one of the ports 193 of the multimedia server 181). Also, in packet 120-3, the source address 125-3 is the address of the configuration server (e.g., global address 180-4), the source port 126-3 is a port (not shown) of the configuration server 185, the destination address 127-2 is the address of the gateway 135 (e.g., global address 180-1), and the destination port 128-3 is a global port 146 (e.g., determined from port 126-2).

In an exemplary embodiment, the local address 129-2 is all that is needed to create a suitable command to configure gateway 135 for content stream 190. In another exemplary embodiment, configuration of the gateway 135 could also depend on the content type (e.g., the number of streams, sometimes the port numbers can be standardized) and not only on the local address 129-2 and/or network appliance ID 114 or 132-1. In yet another exemplary embodiment, the configuration server 185 uses a network appliance ID 114, 132-2 or 173, which is typically a unique ID for each network appliance 105, to determine what gateway (by gateway type 171, for example) is being used. For instance, during registration of the network appliance 105-1 on configuration server 185, the configuration server 185 can ask for the type 171 of gateway 135 being used. The type 171 of the gateway, along with communication information 172 (e.g., communication protocols or other information needed to interface with the remote programming interface 147 of the gateway) can be stored in network appliance registration database 161. The configuration commands 133 are then particular to the gateway 135 being used. It is expected that gateways 135 made from different manufacturers might have different remote programming interfaces 147, and the network appliance registration information 175 in network appliance registration database 161 is used to tailor the configuration commands 133 and gateway configuration information 134 for a particular gateway 135. Typically, multiple network appliance IDs 173 would be correlated with a single gateway type 171.

It should be noted that configuration commands 133 and gateway configuration information 134 can be combined. Additionally, multiple port openings can be requested by a gateway configuration module 163. Thus, configuration commands 133 and gateway configuration information 134 can include multiple global ports 180-1 along with multiple local addresses 196 and local ports 197.

Once the configuration server 185 has configured the gateway 135, the configuration server 185 contacts the remote server 155 to inform the remote server 155 that the gateway 135 is configured. The remote server 155 then will contact the multimedia server 181 so that the multimedia server 181 can begin sending the multimedia content 164 to the network appliance 105-1.

To send the multimedia content 164 to the network appliance 105-1, the content server 162 on the multimedia server 181 creates one or more content streams 190 from the multimedia content 164. Headers (not shown) for packets (not shown) for the content streams 190 could have appropriate global ports 146 and other information (e.g., destination addresses) so that the gateway 135 can determine where to route the content streams 190 and whether to accept the content streams 190.

The gateway configuration information 139, which in this example is one or more tuples (server address, server port, gateway global address, global port, local address, and local port), is used by the gateway 135 to direct the multimedia content stream 190 to the network appliance 105-1. Note that some elements of the above tuple may be absent or not used. The router 138 uses the gateway configuration information 139 during address and port translation for incoming packets. Firewall 140 also comprises gateway configuration information 145, which in this example is a server address, server port, gateway global address, and a global port. The gateway configuration information 145 may be used by the firewall 140 to accept packets having a source address of the server address (e.g., global address 180-3 of the multimedia server 181) and a destination port of the “global port,” which has been determined to be available by the configuration server 185 and is one of the global ports 146. Additionally, the server port (e.g., one of the multimedia ports 193 of the multimedia server 181) and a gateway global address (e.g., global address 180-1) can also be used when the firewall 140 accepts or rejects a content stream 190.

It should be noted that security also will typically be used in FIG. 1. This is explained in more detail below in reference to FIG. 4.

Furthermore, while it is common to combine the firewall 140 and router 138 into gateway 135, firewall 140 and router 138 could be separate. In the latter case, the firewall 140 and router 138 would be configured either separately (e.g., gateway configuration module 163 configures two devices) or jointly (e.g., the two devices have a joint remote configuration interface, one of them gets configuration from gateway configuration module 163, uses it for its own operations and to instruct the other device). Likewise, although multimedia server 181, configuration server 185 and remote server 155 are shown as being separate, they may be combined also.

Additionally, for peer-to-peer multimedia applications like video conferencing, the multimedia content 164 can come from another home, which then houses the multimedia server 181 for sending content stream(s) 190. The network appliance 105 can send some gathered information from a call set up phase (e.g., global port number to be used) to the gateway configuration module 163 (which is typically not in the other home, but which is connected to the external network 160), which will then configure a gateway 135 between the network appliance 105 and the multimedia server 181.

The processors 106, 136, and 156 may be distributed or singular, and the memories 107, 137 or 157 may be distributed or singular. The present invention described herein may be implemented as an article of manufacture comprising a machine-readable medium, as part of memories 107, 137 or 157 for example, containing one or more programs that when executed implement embodiments of the present invention. For instance, the machine-readable medium may contain a program configured to perform steps of the methods shown in FIGS. 2 through 4 below. The machine-readable medium may be, for instance, a recordable medium such as a hard drive, an optical or magnetic disk, an electronic memory, or other storage device.

Referring now to FIG. 2, an exemplary method 200 is shown that is performed by a network appliance in order to provide remotely controlled gateway management. Method 200 begins in step 210 when a user selects multimedia content. A network appliance 105 communicates the selection of the multimedia content in step 210, although the communication may also be combined with step 220. In step 220, the network appliance sends a request to the remote server 155. The request, in this example, comprises a local address, a local port, and a network appliance ID. In step 230, the network appliance 105 waits for a multimedia content stream 190.

Turning now to FIG. 3, an exemplary method 300 is shown that is performed by a gateway in order to provide remotely controlled gateway management. Method 300 begins when a configuration communication is started in step 310 with the configuration server 185. While it is possible for the configuration server 185 to simply command the gateway 135 to configure itself in a certain manner, there may be times when there might be configuration conflicts, such as when a global port 146 is already in use. One way of preventing this problem is for the gateway 135 to reject a command and force the configuration server 185 to send another command. Another way is when the configuration server 185 communicates with the remote programming interface 147 of the gateway 135, then the configuration server 185 can determine, using commands appropriate for the remote programming interface 147, what global ports 146 are available. Step 310 will therefore generally depend on the particular gateway 135 being used.

In step 320, the gateway 135 receives one or more configuration commands. If the gateway 135 does support a configuration communication, then the configuration server 185 will have determined available global ports 146 suitable for use with the gateway 135. Alternatively, the configuration server 185 will simply send a command containing a global port 146 and the gateway 135 can send a rejection to the configuration server 185. Another option is for a command from the configuration server 185 to be a command that tells the gateway 135 to determine a global port 146 suitable for use with the multimedia content stream 190 and to report the global port 146 to the configuration server 185. The configuration commands 133 typically contain or are accompanied by gateway configuration information 134, including such items as a server address (e.g., a global address 180-3 of multimedia server 181), a server port (e.g., a multimedia port 193 for multimedia server 181), a gateway global address (e.g., global address 180-1 of gateway 135), a global port (e.g., one of the global ports 146 of the gateway 135), a local port (e.g., local port 130-2, which is a port 113 of network appliance 105-1), a local address (e.g., local address 129-2 of the network appliance 105-1, which is typically local address 170-1), and a stream type.

A stream type is an optional qualifier used to identify particular multimedia content streams, e.g., TCP, UDP, or RTP over UDP. The stream type can be used to further define the data types that will be communicated through to the gateway 135. Different data types could be rejected, for instance.

In step 330, the gateway 135 determines, from the command received in step 320 for instance, the global port 146 used for the multimedia content stream. In step 340, the gateway 135 configures the firewall 140 with gateway configuration information 145 such as a gateway global address (e.g., global address 180-1), global port (e.g., one of the global ports 146), a server address (e.g., global address 180-3 of the multimedia server 181), a server port (e.g., a multimedia port 193), and an optional stream type. It should be noted that if the content server 162 is joined with the configuration server 185, the server address will generally be a global address 180 used for the combination. In step 350, the gateway 135 configures the router with gateway configuration information 139, which in this example is a gateway global address (e.g., global address 180-1), global port (e.g., one of the global ports 146), a server address (e.g., global address 180-3 of multimedia server 181), a server port (e.g., a multimedia port 193 of multimedia server 181), an optional stream type, a local address (e.g., local address 129-2, which is typically local address 170-1 of the network appliance 105-1), and a local port (e.g., local port 130-2, which is typically one of the local ports 113 of the network appliance 105-1).

In step 360, an acknowledgement is sent to the configuration server 185. This step is optional but beneficial, as the configuration server 185 can then inform the remote server 155 (or the multimedia server 181 or both) to begin transmission of the multimedia content 164 via the multimedia content stream 190. In step 370, the gateway 135 waits for the multimedia content stream 190.

Referring now to FIG. 4, an exemplary method 400 is shown that is performed by a server or several servers in order to provide remotely controlled gateway management.

Method 400 begins in step 410 when the remote server 155 presents a list of multimedia contents 164 to the network appliance 105. Generally, this is performed through a web page but can be performed through any technique allowing selection of multimedia content 164. In step 420, a content selection is received. This content selection may also be a request for content 164, along with the local address 129-2, the local port 130-2, and the network appliance ID 132-2. In step 425, the remote server 155 communicates the request to the configuration server 185.

Steps 430-475 are typically performed by a gateway configuration module 163 of a configuration server 185. In step 430, the configuration server 185 determines gateway communication information. This step could involve determining the specific type of gateway, such as by using network appliance registration information 175 (e.g., from network appliance registration database 161) of a gateway type 171, communication information 172 for the specific gateway, a network appliance ID 173, or some combination thereof. Network appliance registration information 175 is typically gathered during a registration process, which occurs during initial, periodic, or every contact between the network appliance 105 and the remote server 155. The network appliance registration information 175 allows the configuration server 185 to determine specific protocols or instructions used to communicate with the remote programming interface 147 of the gateway 135. As another example, step 430 could entail using a number of known commands for a number of remote programming interfaces 147 until the gateway 135 begins communicating with the remote server 155.

In step 440, a configuration communication is typically entered by the configuration server 185 and the gateway 135. Although not required, step 440 allows a configuration server 185 to query the remote programming interface 147 as to which global ports 146 are available and suitable for use with a content stream 190 created from multimedia content 164.

In step 450, appropriate commands are created for the gateway 135 to configure the gateway 135 to pass one or more content streams 190 created from multimedia content 164. One or more commands, in step 460, are communicated to the gateway 135. These commands cause the gateway 135 to configure itself so that the gateway 135 will pass the one or more content streams 190 created from multimedia content 164 and sent from multimedia server 181 to the appropriate network appliance 105.

The configuration server 185 waits for an acknowledgement in step 470. In step 475, the configuration server 185 informs the remote server 155 that the gateway 135 has been configured for multimedia content 164.

In step 480, the remote server 155 informs the multimedia server 181 that there has been a request from a network appliance 105 for the multimedia content 164.

In step 485, the content server 162 of the multimedia server 181 sends the content stream 190 to the gateway 135 using the appropriate global port 146 and global address 180-1 for the gateway (and typically the global address 180-3 of the multimedia content server 181 and one of the multimedia ports 193 of the multimedia server 181). The content stream 190 can be any type of data, such as text, video, sound, and other information, and is typically carried through the use of one or more protocols, such as TCP or UDP. Generally, one multimedia content 164 will be split into multiple content streams 190, but this is not always the case.

In order to prevent outside users from being able to control the gateway 135, the gateway 135 will generally employ some type of security measures, particularly when the remote programming interface 147 is attempting to be accessed. There are a variety of security measures that can be employed. For example, each communication with remote programming interface 147 might have to be encrypted and authenticated. Public and private keys might be used. Further, passwords or other devices may be used in addition to or in place of the encryption. Thus, the remote server 155 might need to know a unique ID assigned to the gateway 135 or the network appliance ID assigned to the network appliance 105. Consequently, in step 430, the step of determining the gateway communication information can also determine appropriate security measures to be used with the gateway 135.

It should be noted that method 400 assumes that the remote server 155 is informed by the configuration server 185 that the gateway 135 has been configured. However, other options are possible, such as having the configuration server 185 inform the multimedia server 181 to begin sending the content stream 190 or for the gateway 135 to inform the multimedia server 181 to begin sending the content stream 190.

In steps 440 and 460 (and other steps, if desired), the security measures can be implemented in order to provide secure communication between the remote server 155 and the gateway 135.

There is also the possibility that the gateway configuration module 163 can determine gateway configuration information to configure gateway 135 and send the gateway configuration information (e.g., gateway commands 133, gateway configuration information 134) to the network appliance 105. The network appliance 105 then performs the configuration of the gateway through, for instance, use of the remote programming interface 147.

It is to be understood that the embodiments and variations shown and described herein are merely illustrative of the principles of this invention and that various modifications may be implemented by those skilled in the art without departing from the scope and spirit of the invention. For example, although multimedia content has been described herein, any content that is typically broken into smaller portions and sent to a network appliance may be used.

1. A method (e.g., 400) for remotely controlled gateway (135) management, the method (e.g., 400) comprising the steps of:
receiving a request (120-1, 120-2) for content (164), the request (120-1, 120-2) comprising global addressing information (125-2, 126-2) of a gateway (135) and corresponding to one or more network appliances (105) on a local network (165) accessible via the gateway (135);
determining gateway configuration information (139, 145, 134) suitable for configuring the gateway (135) to pass one or more content streams 190, each comprising portions of the content (164), to the one or more network appliances (105); and
communicating the gateway configuration information (139, 145, 134) with the gateway (135).

2. The method (e.g., 400) of claim 1, wherein the step of communicating further comprises the step of communicating the gateway configuration information (139, 145, 134) with the gateway (135) through a secure connection to the gateway (135).

3. The method (e.g., 400) of claim 1, wherein the steps of determining gateway configuration information (139, 145, 134) further comprises the step of determining one or more local addresses (170) of the one or more network appliances (105) and determining a mapping from one or more gateway addresses (180-1, 125-2, 127-3) associated with the gateway (135) to the one or more local addresses (170), wherein the gateway configuration information (139, 145, 134) comprises the mapping.

4. The method (e.g., 400) of claim 1, wherein the steps of determining gateway configuration information (139, 145, 134) further comprises the step of determining one or more stream types for the one or more content streams 190, wherein the gateway configuration information (139, 145, 134) comprises the one or more stream types.

5. The method (e.g., 400) of claim 1, wherein the step of determining gateway configuration information (139, 145, 134) further comprises the step of determining one or more global ports (146) to open on the gateway (135), wherein the gateway configuration information (139, 145, 134) comprises the one or more global ports (146).

6. The method (e.g., 400) of claim 5, wherein the step of determining one or more global ports (146) to open further comprises the step of determining one or more global ports (146) to open on the gateway (135) for the requested content (164).

7. The method (e.g., 400) of claim 5, wherein a given one of the one or more network appliances (105) is associated with a plurality of ports (113), and wherein the step of determining one or more global ports (146) to open on the gateway (135) further comprises the step of determining a mapping (e.g., 139) from the one or more global ports (146) to the plurality of ports (113) for the given network appliance (105), the gateway configuration information (139, 145, 134) comprising the mapping (e.g., 139).

8. The method (e.g., 400) of claim 6, wherein a first content (164) requires more global ports (146) than a second content (164).

9. The method (e.g., 400) of claim 1, wherein:
the request (120-1, 120-2) further comprises information (e.g., 129-1, 130-1, and 132-1) corresponding to the one or more network appliances (105); and
the step of determining gateway configuration information (139, 145, 134) further comprises the step of comparing the information corresponding to the one or more network appliances (105) with stored information (161, 175).

10. The method (e.g., 400) of claim 9, wherein the information (e.g., 129-1, 130-1, and 132-1) corresponding to the one or more network appliances (105) comprises one or more network appliances (105) identifications.

11. The method (e.g., 400) of claim 9, wherein the information (e.g., 129-1, 130-1, and 132-1) corresponding to the one or more network appliances (105) comprises one or more of the following: one or more addresses (129-1) and one or more ports (130-1).

12. The method (e.g., 400) of claim 9, wherein:
the information (e.g., 129-1, 130-1, and 132-1) corresponding to the one or more network appliances (105) comprises a unique identification (114) for each of the one or more network appliances (105);
the stored information (161, 175) comprises a plurality of unique identifications (173) corresponding to a plurality of network appliances (105);
the stored information (161, 175) further comprises a gateway type (171) and a gateway communication information (172) corresponding to one or more network appliances (105); and
the step of determining gateway configuration information (139, 145, 134) further comprises the step of when a match occurs between a unique identification (114) in the information (e.g., 129-1, 130-1, and 132-1) corresponding to the one or more network appliances (105) and a given unique identification (173) in the stored information (161, 175), determining the gateway type (171) and gateway communication information (172) corresponding to the given unique identification (173).

13. The method (e.g., 400) of claim 12, wherein the step of communicating the gateway configuration information (139, 145, 134) further comprises the step of using the gateway communication information (172) in order to communicate with the gateway (135).

14. The method (e.g., 400) of claim 1, wherein the step of communicating the gateway configuration information (139, 145, 134) with the gateway (135) further comprises the step of communicating with a remote programming interface (147) on the gateway (135).

15. The method (e.g., 400) of claim 1, wherein the step of communicating the gateway configuration information (139, 145, 134) with the gateway (135) further comprises the step of sending one or more commands (120-3, 133) to the gateway (135) in order to communicate the gateway configuration to the gateway (135).

16. A system (185) for remotely controlled gateway (135) management, comprising:
a memory (e.g., 107, 137, 157); and
at least one processor (e.g., 106, 136, 156), coupled to the memory (e.g., 107, 137, 157), operative to:
receive a request (120-1, 120-2) for content (164), the request (120-1, 120-2) comprising global addressing information (125-2, 126-2) of a gateway (135) and corresponding to one or more network appliances (105) on a local network (165) accessible via the gateway (135);
determine gateway configuration information (139, 145, 134) suitable for configuring the gateway (135) to pass one or more content streams 190, each comprising portions of the content (164), to the one or more network appliances (105); and
communicate the gateway configuration information (139, 145, 134) with the gateway (135).

17. A method (e.g., 300) for remotely controlled gateway (135) management, the method comprising the steps of:
sending a request (120-1, 120-2) for content (164), the request (120-1, 120-2) comprising global addressing information (125-2, 126-2) of a gateway (135) and corresponding to one or more network appliances (105) on a local network (165) accessible via the gateway (135);
receiving gateway configuration information (139, 145, 134) suitable for configuring the gateway (135) to pass one or more content streams (190), each comprising portions of the content (164), to the one or more network appliances (105); and
configuring the gateway (135) in accordance with the gateway configuration information (139, 145, 134).

18. The method (e.g., 300) of claim 17, wherein:
the step of receiving gateway configuration information (139, 145, 134) suitable for configuring the gateway (135) to pass one or more content streams 190 further comprises the step of determining one or more global ports (146) in the gateway configuration information (139, 145, 134); and
the step of configuring the gateway (135) in accordance with the gateway configuration information (139, 145, 134) further comprises the step of opening the one or more global ports (146).

19. The method (e.g., 300) of claim 18, wherein:
the step of receiving gateway configuration information (139, 145, 134) suitable for configuring the gateway (135) to pass one or more content streams (190) further comprises the step of determining one or more local addresses (170) in the gateway configuration information (139, 145, 134), wherein a given one of the local addresses (170) correlates to a given one of the one or more global ports (146); and
the step of configuring the gateway (135) in accordance with the gateway configuration information (139, 145, 134) further comprises the step of sending a content stream (190) received on the given open port (146) to the given local address (170).

20. The method (e.g., 300) of claim 19, wherein:
the step of receiving gateway configuration information (139, 145, 134) suitable for configuring the gateway (135) to pass one or more content streams 190 further comprises the step of determining one or more local ports (113) in the gateway configuration information (139, 145, 134), wherein a given one of the local ports (113) correlates to the local address (170); and
the step of configuring the gateway (135) in accordance with the gateway configuration information (139, 145, 134) further comprises the step of sending a content stream (190) received on the given open port to the given local address (170) and the given port (113).

21. The method (e.g., 300) of claim 18, wherein:
the step of receiving gateway configuration information (139, 145, 134) suitable for configuring the gateway (135) to pass one or more content streams (190) further comprises the step of determining one or more server addresses (180-3, 198) in the gateway configuration information (139, 145, 134), wherein a given one of the server addresses (180-3, 198) correlates to a given one of the one or more global ports (146); and
the step of configuring the gateway (135) in accordance with the gateway configuration information (139, 145, 134) further comprises the step of rejecting a content stream (190) received on the given global port when a source address (e.g., 125-3) associated with the content stream (190) does not match the given server address (180-3, 198).

22. The method (e.g., 300) of claim 17, wherein the step of configuring the gateway (135) in accordance with the gateway configuration information (139, 145, 134) further comprises the step of configuring a router (138) with the gateway configuration information (139, 145, 134).

23. The method (e.g., 300) of claim 17, wherein the step of configuring the gateway (135) in accordance with the gateway configuration information (139, 145, 134) further comprises the step of configuring a firewall (140) with the gateway configuration information (139, 145, 134).

24. A system (135) for remotely controlled gateway (135) management, comprising:
a memory (137); and
at least one processor (136), coupled to the memory (137), operative to:
send a request (120-1, 120-2) for content (164), the request (120-1, 120-2) comprising global addressing information (125-2, 126-2) of a gateway (135) and corresponding to one or more network appliances (105) on a local network (165) accessible via the gateway (135);
receive gateway configuration information (139, 145, 134) suitable for configuring the gateway (135) to pass one or more content streams 190, each comprising portions of the content (164), to the one or more network appliances (105); and
configure the gateway (135) in accordance with the gateway configuration information (139, 145, 134).
